(19) United States
(12) Patent Application Publication
(10) Pub. No.: US 2015/0001183 A1
(43) Pub. Date: Jan. 1, 2015

(54) Welding Method

(71) Applicant: TI Automotive (Heidelberg) GmbH, Heidelberg (DE)

(72) Inventor: Walter Hersel, Leonberg (DE)

(73) Assignee: TI Automotive (Heidelberg) GmbH, Heidelberg (DE)

(21) Appl. No.: 14/317,380

(22) Filed: Jun. 27, 2014

(30) Foreign Application Priority Data
Jun. 28, 2013 (EP) 13 174 330.4

(51) Int. Cl. B23K 26/22; B23K 26/12; B23K 26/24

(52) U.S. Cl. CPC B23K 26/22; B23K 26/24; B23K 26/123
USPC 219/74; 219/137 R; 219/121.64

(57) ABSTRACT

A welding method, in particular a tack welding method for connecting two components, preferably two components of a fuel system, wherein the regions, of the two components that are to be connected to one another are each heated, and each at least partially melted with a first energy pulse. The partially melted, regions of the two components are connected to one another through the formation of a welding seam. Preferably, after the hardening of the welding seam, a further energy pulse is directed onto the welding seam, with the stipulation that only a midsection of the welding seam is again melted.

### CROSS REFERENCE TO RELATED APPLICATIONS

This patent application claims priority pursuant to Title 35 USC Section 119 to European Patent Application No. 13 174 330,4, filed. Jun. 28, 2013, the entire contents of which are hereby incorporated by reference herein.

### BACKGROUND

The invention relates to a method, in particular a tack welding method, for connecting two components.

Welding methods of the type specified above are known fundamentally in the field. It has proven to be reliable thereby to melt the regions that are to be joined to one another of the components that are to be connected to one another and then to join the two components at the region of the melted regions to form a welding seam. In particular, it has proven to be reliable to melt the surface regions of the two components that are to be joined by means of irradiating them with a laser. It has been shown, however, that the mechanical strength of the welding seam that can be generated with the welding methods known in the practice and their durability are in need of improvement.

For this reason, the invention addresses the technical problem of providing a welding method with which two components can be joined in a permanent, and mechanically very durable manner, and which is distinguished by its simplicity and capacity for being quickly executed.

### SUMMARY OF THE INVENTION

In order to solve the technical problem, the invention teaches of a welding method, in particular a tack welding method, for connecting two components, preferably two components of a fuel system, wherein the regions of the two components that are to be connected, to one another are each heated and are each, at least in part, melted, with at least one first energy pulse, wherein the partially melted regions of the two components are connected to owe another through the formation of a welding seam, and wherein a further pulse of energy, preferably alter the hardening of the welding seam, is directed onto the welding seam, with the stipulation that only a midsection of the welding seam is again melted. The midsection of the welding seam means, in particular, a section of the welding seam that is located between the two components when the components have been joined, or connected, to one another after being subjected to the first pulse of energy. It has been shown, that the midsection of the welding seam is the region of the welding seam that is roost strongly mechanically loaded.

The components concern, by way of example, fuel lines, preferably, of a gasoline direct injection system (GDI system). The components preferably consist of the same material, e.g. a stainless steel according to one embodiment. It is possible that the components are each made of a plastic. Fundamentally, it is also possible that the two components are made of different materials, such as different steels, for example. For practical purposes, the components that are to be connected to one another are aligned such that they face one another prior to the formation of the welding seam. That the two components are joined, or connected to one another through the formation of a welding seam means, in the scope of the invention, in particular, that the two components are connected to one another in a material bonding manner.

It is particularly preferred that the regions of the two components that are to be connected to one another are each heated and partially melted with only one first energy pulse. It is possible that the regions of the two components that are to be connected to one another are each heated and melted with a plurality of first energy pulses. The regions of the two components that are to be connected to one another concern, for practical purposes, regions of a wall of the respective component in each case, wherein it is recommended that said regions are connected to one another in a material bonding manner. According to one embodiment, the energy for the first and/or further energy pulse(s) can be varied over the course of the energy pulse.

According to one embodiment, a volume segment of the welding seam bordering a surface of the welding seam is melted. For practical purposes, the melted volume segment is in the shape of a ring, and forms a portion of fee surface of the welding seam formed by the heated and/or melted regions of the two composers. It is within the scope of the invention that, starting from the surface of the volume segment of the welding seam, a temperature gradient toward a back side of the component facing away from the surface is formed through the heated regions of each component, wherein a temperature of the component, starting from the surface of the melted volume segment, decreases toward the back side of the component.

Preferably, the further energy pulse, after the joining, or connecting, of the two components, is directed toward the welding seam after the, preferably, partial hardening of the heated and/or melted regions of the two components. It is recommended that the volume segment is melted with the former energy pulse, when, in particular, a section of the welding seam, preferably encompassing the volume segment radially, is not yet hardened after being subjected to the first energy pulse. In this manner, fissures in the welding seam are closed, which may have formed due, for example, to the cooling of the welding seam, and which compromise the durability of the welding seam. Fundamentally, it is possible that, after the correcting of the two components, and after the hardening of the regions of the two components melted by the first energy pulse, a plurality of further energy pulses is directed toward the welding seam. It is particularly preferred that only one further energy pulse is directed toward the welding seam.

It is within the scope of the invention that the first energy pulse and/or the further energy pulses are laser pulses. Fundamentally, it is possible that the first energy pulse and/or the further energy pulse is an energy pulse selected from the group “electric arc pulse, current pulse, plasma jet pulse, sonic pulse, electron pulse.”

Preferably, the first energy pulse and/or the further energy pulse is generated by means of the same laser source. Fundamentally, it is possible that, in order to generate the first and/or further energy pulse, different pulse sources, in particular current laser sources, are used.

It is recommended that a position for the energy pulse source, preferably the laser source, remains unchanged, or unvaried, during the directing of the first energy pulse and/or the further energy pulse onto the components. It is possible that the energy source, preferably the laser source, is connected to a handling unit or control unit, respectively, wherein the position and/or orientation of the energy pulse source, preferably the laser source, is not altered, or remains unchanged, during the irradiation of the components with the first energy pulse and/or the bulbar energy pulse.

According to one embodiment, the further energy pulse is directed onto the components 20-200 milliseconds after the first energy pulse. According to one preferred embodiment, the further energy pulse is directed onto tire components 40-120 milliseconds after the first energy pulse. It is possible that the further energy pulse is directed onto the components 50-100 milliseconds after the first energy pulse. It is within the scope of the invention that the further energy pulse is directed onto the midsection of the welding seam after, in particular, it has completely cooled and/or hardened.

According to a preferred embodiment, the energy for the further energy pulse is less than the energy tor the first energy pulse. In this manner it is ensured that only the midsection of the welding seam is again melted by the further energy pulse, without re-melting wall regions, or the walls, respectively of the two components. Fissures in the welding seam can be reliably closed by the irradiation of the midsection of the welding seam with the further energy pulse, without fear of weakening the welding seam.

For practical purposes, the diameter of the further energy pulse is smaller than the diameter of the first energy pulse. It is particularly preferred that the irradiation of the midsection of the welding seam with the further energy pulse is directed onto the midsection of the welding seam, in order to eliminate, or minimize, a heating of the wall regions of the components where the welding seam is applied.

It is possible that the welding seam is generated without adding additional welding flux. Fundamentally, it is possible that the welding seam is formed through the application of a welding flux. The welding flux preferably consists of the same material as the walls of the components.

The invention is based on the knowledge that, with the method according to the invention two components can be connected to one another in a permanent and mechanically durable manner. With the method according to the invention, the formation of fissures in the welding seam can be prevented in an advantageous manner, these fissures being formed during the cooling of the welding seam immediately after it has been created when using the method, known in the field. The method according to the invention is distinguished thereby by its being simple to execute, and its having a high degree of fractional reliability, whereby the testing of the welding seam following the welding procedure is very simple, and, if necessary, can even be omitted. To this extent, the method according to the invention Is distinguished by a high operational reliability, and economic efficiency. In an advantageous manner, the method, according to the invention can be executed quickly, such that numerous welding procedures can be reliably executed in a surprisingly short period of time.

### DESCRIPTION OF THE DRAWINGS

The invention shall be explained hi greater detail below, based on drawing depicting a single embodiment example. Shown are, schematically:

FIG. 1 a top view of a welding seam, according to the prior art,

FIG. 2 a top mew of a welding seam generated with, the method according to the invention,

FIG. 3 a cut through a welding scam generated with the method according to the invention, after irradiation with the first energy pulse, and

FIG. 4 a cut through a welding seam generated with the method according to the invention, after irradiation with the further energy pulse.

### DETAILED DESCRIPTION OF ILLUSTRATED EMBODIMENTS

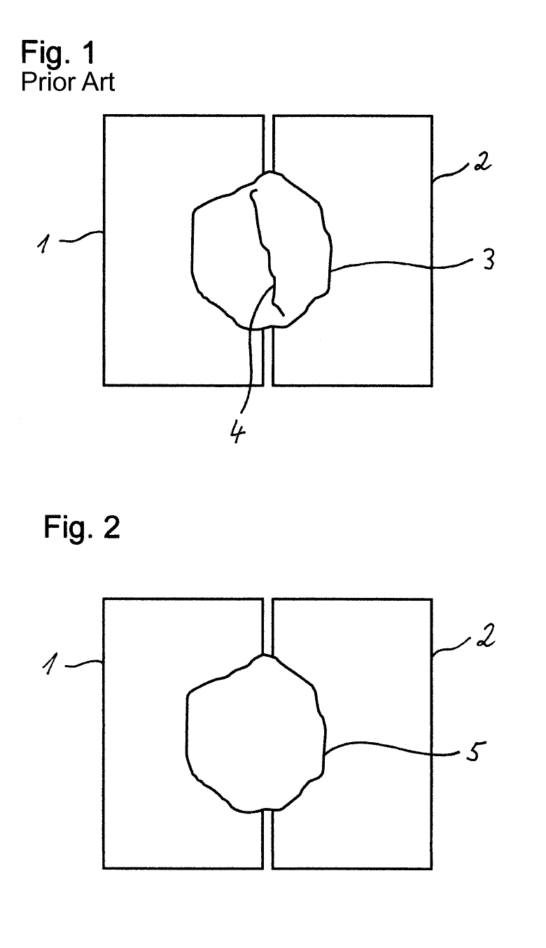

Turning now to the drawings, two components 1, 2 are depicted in FIG. 1, which are joined to one another by means of a welding seam 3 according to the welding method known from to the prior art. It can be seen that the welding seam 3 has a fissure 4, by means of which fissure 4 the welding seam 3 is weakened such that the components 1, 2 are not reliably connected to one another.

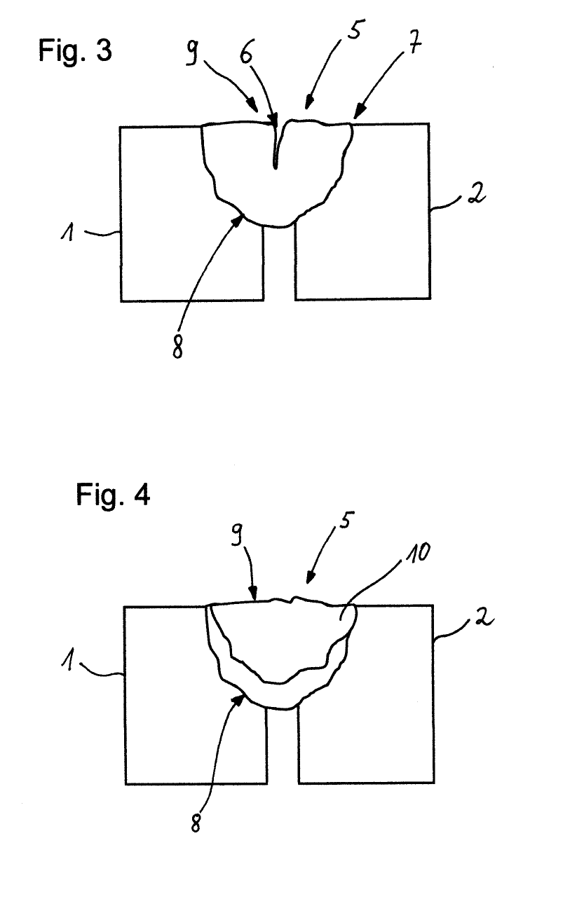

With the method according to the invention, welding seams 5 can be generated in which the welding seams 5 are formed without fissures, and with which the two components 1, 2 are reliably joined, in accordance with FIG. 2. In accordance with, the embodiment example, and as shown in FIG. 3, a region 8 bordering on a surface 7 of the component 1 is heated and melted by means of a first laser pulse. Subsequently, the component 1 is connected to the component 2, depicted in FIGS. 3 and 4, likewise having a heated and melted region 8, through, the formation of the welding seam 5. The welding seam 5 is formed by a wall material, or material of the components 1,2 in the melted regions 8, in accordance with the embodiment example.

It has been shown that a midsection 9 of the welding seam 5 is subjected to a particular tension resulting from the hardening of the material forming the welding seam 5, and as a result of the hardening of the material in the midsection 9, fissures 6 can form, as is shown in FIG. 3. By irradiating the midsection 9 with a further laser pulse, the fissures 6 formed after the hardening of the midsection 9 are closed in that a volume segment 10 of the midsection 9 is again melted. As a result a welding seam 5 in accordance with. FIG. 4 is formed as a welding seam 5 without fissures. According to the embodiment example, the further laser pulse has a lower energy than the first laser pulse.

Variations and modifications of the foregoing are within the scope of the present invention. It is understood that the invention disclosed and defined herein extends to all alternative combinations of two or more of the individual features mentioned or evident from the text and/or drawings. All of these different combinations constitute various alternative aspects of the present invention. The claims are to be construed to include alternative embodiments to the extent permitted by the prior art.

1. A welding method, for connecting two components, comprising at least partially melting adjacent regions of the two components to be connected to one another with at least one .first energy pulse, wherein the partially melted regions of the two components are connected to one another through the formation of a welding seam, and applying a further energy pulse onto the welding seam alter at least partial hardening of the welding seam.

2. The welding method according to claim 1, wherein on applying a further pulse only a midsection of the welding seam is melted again.

3. The method according to claim 1, wherein on applying said further energy pulse, a volume segment bordering on a surface of the welding seam is melted.

4. The method according to claim 1, wherein the further energy pulse is directed, onto the welding seam after the joining of the two components and alter the preferably partial hardening of the regions heated and/or melted by the first energy pulse,

5. The method according to claim 1, wherein the energy poises are laser pulses.

6. The method according to claim 1, wherein the energy pulses are generated by means of the same energy source.

7. The method according to claim 1, wherein a position for the energy source, during the focusing of the first energy pulse and the further energy pulse onto the two components remains unchanged.

8. The method according to claim 1, wherein the further energy pulse is directed onto the components 20-200 milliseconds after the first energy pulse.

9. The method according to claim 1, wherein the energy for the further energy pulse is less than the energy for the first energy pulse.

10. The method according to claim 1, wherein the diameter of the further energy pulse is smaller than the diameter of the first energy pulse.

11. The method according to claim 1, wherein the welding seam is generated without the addition of an additional welding flux.

12. The method according to claim 1, wherein the welding seam is formed through the addition of a welding flux.

13. The welding method according to claim 1 wherein said welding seam is hardened before said further energy pulse is applied thereto.

14. The welding method according to claim 1 wherein said two components are two components of a fuel system.
